(19) United States
(12) Patent Application Publication
(10) Pub. No.: US 2026/0330175 A1
(43) Pub. Date: Oct. 22, 2026

(54) RADIO FREQUENCY IDENTIFICATION (RFID) RING WITH BOOSTER ANTENNAS

(71) Applicant: LINXENS HOLDING, Mantes la Jolie (FR)

(72) Inventor: Stephan RADKE, Dresden (DE)

(21) Appl. No.: 19/486,672

(22) PCT Filed: May 24, 2023
(86) PCT No.: PCT/IB2023/000271

§ 371 Date: Nov. 21, 2025

(51) Int. Cl. G06K 19/077; H01Q 1/22; H01Q 1/24; H01Q 7/00; H01Q 21/00

(52) U.S. Cl. CPC G06K 19/07762; H01Q 1/2216; H01Q 1/248; H01Q 7/00; H01Q 21/00

(57) ABSTRACT

The present invention refers to a Radio Frequency Identification (RFID) ring comprising a main body having an annular shape and comprising a flexible substrate extending along the perimeter of the main body; a main antenna configured to provide energy to a RFID chip; and an array of booster antennas comprising two or more booster antennas, which are coupled to the main antenna. The main antenna and the booster antennas are formed on the flexible substrate and they are one adjacent to the other, and they are distributed along the length of the flexible substrate so that any antenna of the array is coupled to the main antenna, either directly or indirectly via one or more of the other antennas of the array.

### RELATED APPLICATION

This Application is a national phase application of and claims the benefit of priority to PCT Application No. PCT/IB2023/000271, filed May 24, 2023, the contents of which is incorporated by reference herein.

### TECHNICAL FIELD

The present invention refers to the field of Radio Frequency Identification (RFID) devices. In particular, the present invention refers to the field of RFID rings.

### STATE OF THE ART

The RFID rings known at the state of the art are used, for instance, to unlock a RFID enabled mobile device or another object, such as a vehicle or a door, to authorize payments or transactions, to share data with other devices, and to start predefined applications with custom settings.

A particular configuration of a RFID ring is disclosed for example in document EP 3837639 A1. In this configuration, the RFID ring comprises a RFID transponder, on which data that can be read out are stored, which for example serve to identify the user or their access or authorization rights. To this purpose, the RFID transponder is connected with an antenna structure or itself has an integrated antenna structure by means of which signals can be exchanged with a reading device.

In view of its cylindrical geometry, the read-range of a RFID ring is typically limited, because the communication field can only be induced in the portion of the RFID ring wherein the antenna is located.

In fact, in a first configuration known at the state of the art, the RFID ring is provided with a wire coil formed along the perimeter of the ring, so as to exploit its cylindrical geometry. However, this solution has the disadvantage that the magnetic field generated by the current induced in the wire coil is orthogonal to the plane defined by the ring, or, in other words, the magnetic field is parallel to the finger inserted in the ring. Therefore, to be able to use the RFID ring, the user must orient the RFID ring and the finger in such a way that the magnetic field generated by the current of the wire coil is directed toward the corresponding reader device.

In a second configuration known at the state of the art, the RFID ring is provided with an etched PCB antenna. However, this solution has the disadvantage that the RFID communication is enabled only in correspondence of the portion of the ring where the antenna is located.

In view of the disadvantages discussed above, the present invention aims at providing a RFID ring with an increased read-range.

### SUMMARY

According to a first aspect of the present invention, an RFID ring is provided, the RFID ring comprising:
a main body having an annular shape and comprising a flexible substrate extending along the perimeter of the main body;
a main antenna configured to provide energy to a RFID chip;
an array of booster antennas comprising two or more booster antennas, the booster antennas being coupled to the main antenna,
   wherein the main antenna and the booster antennas are formed on the flexible substrate and they are one adjacent to the other, and wherein the booster antennas are distributed along the length of the substrate so that any antenna of the array is coupled to the main antenna either directly or indirectly via one or more of the other antennas of the array.

The advantage of this configuration is that it enables increasing the read-range and the communication performances of the RFID ring. In fact, the main antenna and the booster antennas are advantageously placed one adjacent to the other so as to cover the surface of the main body of the RFID. The different booster antennas can receive electro-magnetic signals generated by a reader and coming from different directions and can transfer them to the main antenna, which, on its turn, is configured to provide energy to a RFID chip. The booster antennas are advantageously distributed along the length of the substrate with a predefined distance between each other and with a predefined distance from the main antenna, so that the signal received by a booster antenna can finally reach the main antenna and activate the chip. In this way, the RFID ring can receive and process electro-magnetic signals coming from different directions and is not limited to a predefined communication direction.

According to a preferred configuration, the array of booster antennas comprises three booster antennas and the antennas are positioned one adjacent to the other along the surface of the ring body so that one booster antenna is placed in front of the main antenna, and the other booster antennas are placed at either sides of the main antenna. In other words, the main antenna and the three booster antennas according to a preferred configuration are positioned in correspondence of a null angle defined along the perimeter of the ring, and then, respectively, in correspondence of an angle of 90°, 180°, and 270°.

According to an alternative preferred configuration, the array of booster antennas comprises four booster antennas and the antennas are positioned one adjacent to the other along the surface of the ring body so that two booster antennas are placed on one side of the main antenna and two booster antennas are placed on the opposite side of the main antenna.

The size of the main antennas and the booster antennas is advantageously designed so as to maximize the surface of the ring body covered by the antennas. Moreover, the size of the main antennas and the booster antennas is advantageously designed so as minimize interference between the antennas and to maximize inductive coupling. Preferably, the size of the booster antennas is the same as the size of the main antenna. According to an alternative configuration, the main antenna is larger than the booster antennas.

The substrate of the main and booster antennas is advantageously flexible, so that it can be bent to form a ring-shaped structure. For instance, the flexible substrate may comprise a flexible PCB.

It is to be understood that the booster antennas can be directly or indirectly coupled to the main antenna. A booster antenna is directly coupled to the main antenna if they are inductively coupled and the electro-magnetic signal is received from the booster antenna and then directly transmitted to the main antenna. A booster antenna is indirectly coupled to the main antenna if the booster antenna receives the electro-magnetic signal and transmits it to a second booster antenna via inductive coupling, and then the second booster antenna transmits it to the main antenna, or even to a third booster antenna that transmits it to the main antenna. In other words, a booster antenna is indirectly coupled to the main antenna if it receives the electro-magnetic signal and then transmits it to the main antenna via a chain of inductively coupled booster antennas.

According to an embodiment of the present invention, an RFID ring is provided, wherein the main antenna and the booster antennas are distributed along the length of the flexible substrate so that, an induced electro-magnetic signal is generated in the main antenna either directly or indirectly via one or more of the booster antennas of the array, irrespective of the direction of an incoming magnetic field.

The advantage of this configuration is that, when a user wears the RFID ring, it is not necessary to orient the finger and the RFID ring 100 so that the main antenna 20 faces the RFID reader. In fact, thanks to the presence of the booster antennas, the electromagnetic signals coming from different directions can be received regardless of the orientation of the RFID ring 100 and the user's finger.

According to another embodiment of the present invention, an RFID ring is provided, wherein the main antenna and the booster antennas are evenly distributed along the length of the substrate.

The main antenna and the booster antennas are advantageously evenly distributed, so as to maximize the surface of the substrate covered by the antennas and to enable signal reception at different angles.

According to another embodiment of the present invention, a RFID ring is provided, wherein the main antenna and the booster antennas are distributed along the length of the flexible substrate according to an n-fold rotational symmetry.

This distribution of the antennas is advantageous because it allows to optimize reception of electromagnetic signals coming from different directions.

According to this embodiment, the main antenna and the booster antennas are positioned along the perimeter of the RFID ring so as to define an n-fold rotational symmetry, i.e. so that the RFID ring looks substantially the same after a rotation by a partial turn of 360°/n.

In the present disclosure, it is to be understood that “an n-fold rotational symmetry” refers to and protects both an exact n-fold rotational symmetry and a substantially n-fold rotational symmetry. With “substantially n-fold rotational symmetry” a configuration is meant, wherein the n antennas are distributed along the perimeter of the ring so that at least one point of each antenna is separated by an angle of 360°/n to at least one point of the following antenna along the perimeter and this applies for all the n antennas of the ring. In other words, given a number n of antennas, an n-fold rotational symmetry (exact or substantial) is satisfied if it is possible to identify a series of n points, wherein each point belongs to an antenna and is separated by an angle of 360°/n from the previous point and the next point of the series. In this way, by starting from a particular point along the perimeter of the RFID ring wherein at least a portion of a first antenna is formed, and by making a rotation by an angle of 360°/n, the user arrives at a point where at least a portion of a second antenna is formed. For example, in the present disclosure, a set of antennas formed along the perimeter of the RFID ring can be considered to be positioned according to an n-fold symmetry even if the different antennas have different sizes, as long as the principle described above applies.

For example, the main antenna and the booster antennas may be positioned according to a four-fold rotational symmetry, when three booster antennas are provided, or a five-fold rotational symmetry, when four booster antennas are provided.

According to another embodiment of the present invention, an RFID ring is provided, wherein the flexible substrate is a single-sided substrate and the main antenna and the array of booster antennas are formed on the same side of the flexible substrate.

The advantage of this configuration is that it is economical and easy to manufacture and produce.

It is understood that a “single-sided substrate” indicates a substrate which is manufactured only on one side. For instance, a single-sided etched substrate refers to a substrate which is etched only on one side.

According to another embodiment of the present invention a RFID ring is provided, wherein the array of booster antennas is formed so that at least two adjacent booster antennas have one portion in common, preferably all adjacent booster antennas have one portion in common.

The advantage of this configuration is that the read-range and the communication performance of the RFID ring are further increased.

According to another embodiment of the present invention, a RFID ring is provided, wherein the flexible substrate is a double-sided substrate having a first side and a second side, and wherein the main antenna is formed on the first side and the array of booster antennas is split between the first side and the second side, so that at least one booster antenna is formed on the first side and at least one booster antenna is formed on the second side.

The advantage of this configuration is that is simplifies the manufacture of overlaying portions of the antennas.

It is understood that a “double-sided substrate” indicates a substrate which is manufactured on both sides. For instance, a double-sided etched substrate refers to a substrate which is etched on both sides.

According to another embodiment of the present invention, a RFID ring is provided, wherein the main body further comprises an additional flexible substrate layered on the first flexible substrate, and wherein the main antenna is formed on a first side of the flexible substrate and the array of booster antennas is split between the flexible substrate and the additional flexible substrate, so that at least one booster antenna is formed on the first side of the substrate and at least one booster antenna is formed on a second side of the additional substrate.

The advantage of this configuration is that is simplifies the manufacture of overlaying portions of the antennas.

Preferably, the two flexible substrates are two flexible PCBs that form a multi-layered PCB.

According to another embodiment of the present invention, a RFID ring is provided, wherein the array of booster antennas is formed so that at least two adjacent booster antennas formed on different sides have one overlaying portion, preferably all adjacent booster antennas formed on different sides have one overlaying portion.

The advantage of this configuration is that the read-range and the communication performance of the RFID ring are further increased.

According to another embodiment of the present invention a RFID ring is provided, wherein the main antenna and/or the booster antennas are etched antennas.

According to another embodiment of the present invention, a RFID ring is provided, wherein the main antenna and/or the booster antennas are printed antennas.

According to another embodiment of the present invention, a RFID ring is provided, wherein the main antenna and/or the booster antennas are wire-embedded antennas.

According to another embodiment of the present invention, a RFID ring is provided, wherein the booster antennas comprise at least one capacitor for tuning the resonance frequency.

The advantage of this configuration is that the resonance frequency of the booster antennas can be finely tuned in order to match the resonance frequency of the transponder.

Preferably, the transponder has a resonance frequency of 13.65 MHz and the booster antennas comprise one or more capacitors to match this resonance frequency. Preferably, each booster antenna comprises one or more capacitors.

According to another aspect of the present invention, a method for forming a RFID ring is provided, the method comprising the following steps:
a) Providing a flexible substrate;
b) Forming a main antenna on the flexible substrate, the main antenna being configured to provide energy to a RFID chip;
c) Forming an array of booster antennas comprising two or more booster antennas on the flexible substrate, the booster antennas being coupled to the main antenna, wherein the main antenna and the booster antennas are one adjacent to the other and wherein the booster antennas are distributed along the length of the substrate so that any antenna of the array is coupled to the main antenna either directly or indirectly via one or more of the other antennas of the array;
d) Bending the substrate to obtain a ring-shaped structure.

The advantage of this configuration is that it enables increasing the read-range and the communication performances of the RFID ring. In fact, the main antenna and the booster antennas are advantageously placed one adjacent to the other so as to cover the surface of the main body of the RFID. The different booster antennas can receive electro-magnetic signals generated by a reader and coming from different directions and can transfer them to the main antenna, which, on its turn, is configured to provide energy to a RFID chip. The booster antennas are advantageously distributed along the length of the substrate with a predefined distance between each other and with a predefined distance from the main antenna, so that the signal received by a booster antenna can finally reach the main antenna and activate the chip. In this way, the so-produced RFID ring can receive and process electro-magnetic signals coming from different directions and is not limited to a predefined communication direction.

According to another aspect of the present invention, a method for forming a RFID ring is provided, wherein the flexible substrate is a single-sided substrate and the step c) comprises forming the array of booster antennas on the same side of the flexible substrate where the main antenna is formed.

The advantage of this method is that it is simple and economical.

According to another aspect of the present invention, a method for forming a RFID ring is provided, wherein the step c) further comprises forming the two or more booster antennas so that at least two adjacent booster antennas have one portion in common.

The advantage of this method is that it increases the read-range and communication performance of the so-produced RFID ring.

According to another aspect of the present invention, a method for forming a RFID ring is provided, wherein the flexible substrate is a double-sided substrate having a first side and a second side, and wherein the step b) comprises forming the main antenna on the first side, and the step c) comprises splitting the two or more booster antennas between the first side and the second side, so that at least one booster antenna is formed on the first side and at least one booster antenna is formed on the second side.

The advantage of this method is that it simplifies manufacturing overlaying portions of the antennas.

According to another aspect of the present invention, a method for forming a RFID ring is provided, the method further comprising the following step:
e) Providing an additional flexible substrate and overlaying it to the flexible substrate;

Wherein the step b) comprises forming the main antenna on a first side of the substrate and the step c) comprises splitting the two or more booster antennas between the flexible substrate and the additional flexible substrate, so that at least one booster antenna is formed on the first side of the substrate and at least one booster antenna is formed on a second side of the additional substrate.

The advantage of this method is that it simplifies manufacturing overlaying portions of the antennas.

According to another aspect of the present invention, a method for forming a RFID ring is provided, wherein the step c) further comprises forming the array of booster antennas so that at least two adjacent booster antennas formed on different sides have one overlaying portion.

The advantage of this method is that it increases the read-range and communication performance of the so-produced RFID ring.

### FIGURES

FIG. 1 schematically illustrates a three-dimensional view of a RFID ring according to an embodiment of the present invention.

FIG. 2 schematically illustrates a top view of a RFID ring in an unraveled configuration, according to an embodiment of the present invention.

FIG. 3 schematically illustrates a top view of a RFID ring in an unraveled configuration, according to another embodiment of the present invention.

FIG. 4 schematically illustrates a top view of a RFID ring in an unraveled configuration, according to another embodiment of the present invention.

FIG. 5 schematically illustrates a top view of a RFID ring in an unraveled configuration, according to another embodiment of the present invention.

FIG. 6 schematically illustrates a top view of a RFID ring in an unraveled configuration, according to another embodiment of the present invention.

FIG. 7A schematically illustrates a cross-sectional view of a RFID ring, according to an embodiment of the present invention.

FIG. 7B schematically illustrates a cross-sectional view of a RFID ring, according to another embodiment of the present invention.

### DETAILED DESCRIPTION

In the following, the present invention is described with reference to particular embodiments, as is illustrated in the enclosed figures. However, the present invention is not limited to the particular embodiments described in the following detailed description and shown in figures. Instead, the described embodiments simply exemplify the different features of the present invention, the scope of which is defined in the claims. Further modifications and variations of the present invention will be clear to the skilled person.

In the following detailed description, the terms “right”, “left” and variations thereon are employed with reference to the orientation shown in the figures.

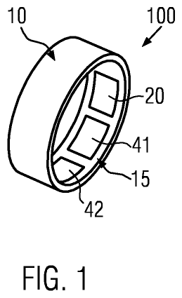

FIG. 1 shows an RFID ring 100 according to an embodiment of the present invention. The RFID ring 100 is configured to carry out radio frequency identification communication with an RFID reader, for instance, for medical applications, transaction applications, or security applications. The RFID ring 100 includes an RFID chip (not visible in FIG. 1) and a main RFID antenna 20. The RFID ring 100 may be used, for example, to unlock an RFID enabled mobile device or another object, to authorize transactions, such as fair payments, to share data with other devices, and to start predefined applications with custom settings.

The RFID ring 100 comprises a main body 10 that has an annular shape, on which a flexible substrate 15 for accommodating electronic components is formed. The flexible substrate 15 is bent to adapt to the annular shape of the main body 10 of the ring.

In view of this cylindrical geometry, radio frequency communication between the main antenna 20 and the RFID reader is efficient only when the user positions the RFID ring 100 so that the main antenna 20 is oriented towards the RFID reader. However, this limits the communication performance and the read-range of the RFID ring 100.

Therefore, the RFID ring 100 according to the present invention is provided with an array of booster antennas 40 formed along the perimeter of the flexible substrate 15, in order to enhance the communication with the RFID reader. The booster antennas 40 are placed one adjacent to the other and they are designed so as to enable inductive coupling between themselves.

The booster antennas 40 are positioned at different angles along the perimeter of the main body 10 of the RFID ring 100. Hence, they can receive and transmit electromagnetic signals coming from different directions.

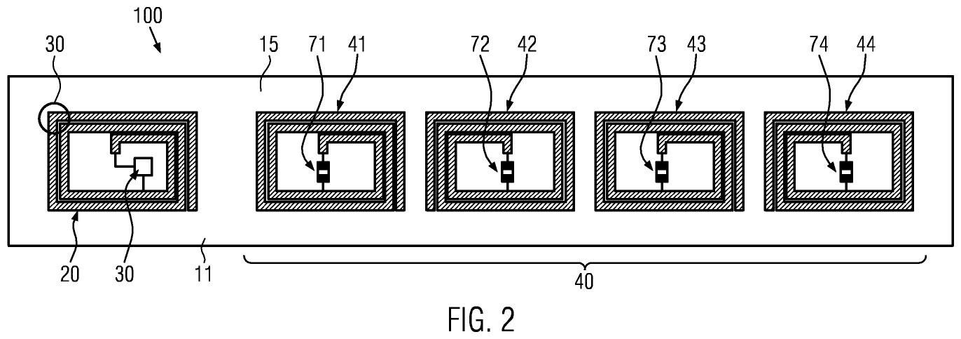

FIG. 2 schematically illustrates a two-dimensional view of the flexible substrate 15 of the RFID ring 100 according to an embodiment of the present invention. The flexible substrate 15 is shown in the unraveled configuration, to better show the different electronic components formed on this flexible substrate 15. The flexible substrate 15 may be, for instance, a flexible PCB.

The electronic components formed on the flexible substrate 15 are (from the left to the right): the main RFID antenna 20, which is connected to the RFID chip 30, a first booster antenna 41, a second booster antenna 42, a third booster antenna 43, and a fourth booster antenna 44. The booster antennas 41, 42, 43 and 44 form the booster array 40.

It is to be understood that, even if four booster antennas are shown in FIG. 2 and in the other figures, any number of booster antennas may be formed on the flexible substrate, for instance two, three, five, or more. Preferably, three or four booster antennas are formed on the flexible substrate 15. In fact, this number of booster antennas ensures a good covering of the surface of the flexible substrate 15, so as to receive different electromagnetic signals coming from different directions, and, at the same time, it ensures a correct coupling between the antennas, so as to transfer the signal to the main antenna 20 and to the RFID reader.

Preferably, the booster antennas 41, 42, 43, and 44 are further connected to the capacitors 71, 72, 73, and 74, respectively, to tune the resonance frequency and to match the resonance frequency of the antenna 20.

In the configuration of FIG. 2, the dimensions of the main antenna 20 are the same as the dimensions of the booster antennas 41, 42, 43 and 44. Alternatively, the dimensions of the main antenna 20 may be larger than those of the booster antennas 41, 42, 43 and 44.

During operation of the RFID ring 100, an alternating magnetic field may be generated by an RFID reader. The magnetic field may reach directly the main antenna 20, or it may reach one of the booster antennas of the array 40, depending on the position of the antennas 20 or 40 along the perimeter of the RFID ring 100 and on the direction of the incoming magnetic field. Accordingly, an induced current and an induced voltage signals may be generated in the main antenna 20 or in the booster antennas of the array 40.

If the induced voltage is generated directly in the main antenna 20, the main antenna 20 transfers energy to the RFID chip 30 and enables communication with the RFID reader.

If the induced voltage is generated in one of the booster antennas of the array 40, the energy is first transferred from the booster antenna 40 to the main antenna 20 via inductive coupling and then to the RFID chip 30, to enable communication with the RFID reader.

Depending on their position along the perimeter of the flexible substrate 15, the booster antennas of the array 40 may be directly or indirectly coupled to the main antenna 20. For instance, with reference to the configuration of FIG. 2, the booster antennas 41 and 44 are positioned next to the main antenna 20 in the raveled RFID ring 100, hence they can directly transfer energy to the main antenna 20 via inductive coupling.

On the other hand, with reference to the configuration of FIG. 2, the booster antennas 42 and 43 are not positioned next to the main antenna 20. Therefore, if an induced electromagnetic signal is generated in the booster antennas 42 and/or 43, they first transfer energy to the neighboring booster antennas 41 and/or 42 via inductive coupling. Then, the booster antennas 41 and/or 42 can, in turn, transfer energy to the main antenna 20 via inductive coupling. This configuration is referred to in the present disclosure as “indirect inductive coupling”.

The size and position of the booster antennas 40 are designed so as to enable direct and indirect coupling with the main antenna.

It appears from the above explanation that, since an array 40 of booster antenna is formed along the perimeter of the flexible substrate 15, the RFID ring 100 is able to receive electromagnetic signals directed towards the main antenna 20 or towards one of the booster antennas 41, 42, 43 or 44. Therefore, the overall read-range of the RFID ring 100 is increased.

According to illustrative embodiments, the antennas may be made by means of printing technology, wire embedding technology or etching technology.

During production of the RFID ring 100, after forming the main antenna 20 and the array of booster antennas 40, the flexible substrate 15 is wrapped around the main body 10 to form a ring-shaped structure. In this way, an operator can use the RFID ring 100 by inserting their finger in the opening of the RFID ring 100. Thanks to the presence of the booster antennas 40, it is not necessary to orient the finger and the RFID ring 100 so that the main antenna 20 faces the RFID reader. In fact, the electromagnetic signals coming from different directions can be received regardless of the orientation of the RFID ring 100 and the user's finger.

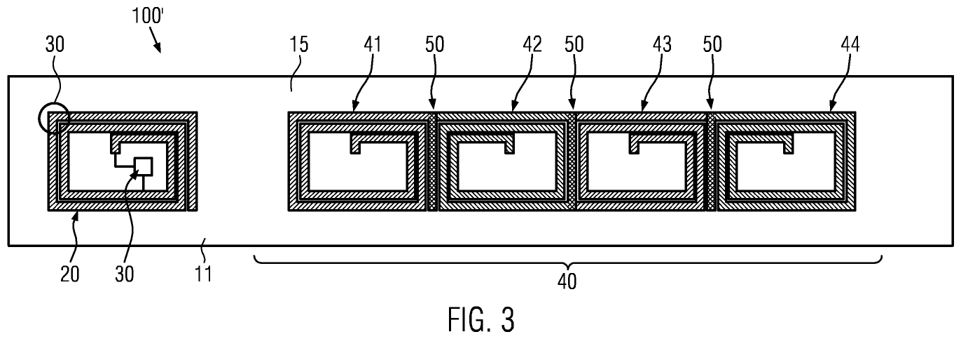

FIG. 3 schematically illustrates a two-dimensional view of the RFID ring 100′, according to another embodiment of the present invention. The flexible substrate 15 is shown in the unwrapped configuration, so that the electronic components formed thereon are clearly visible.

In the configuration of FIG. 3, the booster antennas 41, 42, 43 and 44 are positioned adjacent to each other, so that at least one portion of one booster antenna overlaps with at least one portion of the adjacent booster antenna. As illustrated in FIG. 3, the booster antenna 41 has an overlapping portion 50 with the booster antenna 42, the booster antenna 42 has an overlapping portion 50 with the booster antenna 43, and the booster antenna 43 has an overlapping portion 50 with the booster antenna 44. This configuration is advantageous because the read-range performance of the RFID ring 100′ is further enhanced.

In the configuration of FIG. 3, the booster antennas 41, 42, 43 and 44 are formed on the same side 11 of the flexible substrate 15. The flexible substrate 15 is hence a single-sided substrate, which is more economical to manufacture.

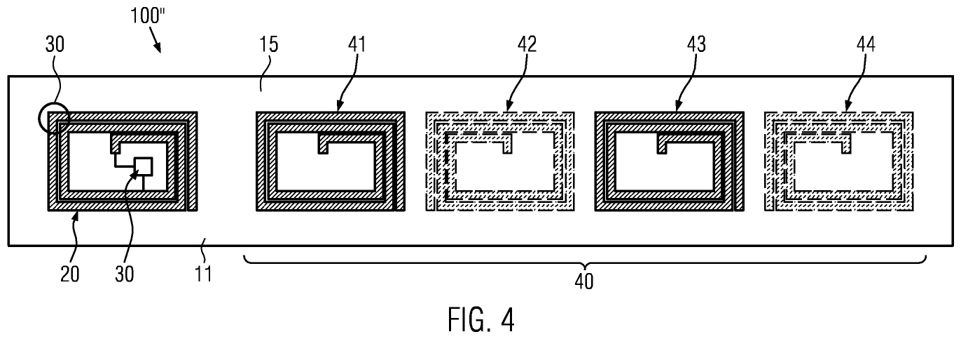

FIG. 4 schematically illustrates a two-dimensional view of the RFID ring 100″, according to an alternative embodiment of the present invention. The flexible substrate 15 is shown in the unraveled configuration, so that the electronic components formed thereon are clearly visible.

In the configuration of FIG. 4, the flexible substrate 15 is a double-sided substrate, which has a first side 11 and a second side (not visible in the figure). Both sides are manufactured. For instance, the double-sided substrate 15 may be a double-sided PCB with booster antennas formed on the opposite sides.

In the configuration of FIG. 4, the array 40 of booster antennas is split between the first side 11 and the second side of the flexible substrate 15, such that the booster antennas 41 and 43 are formed on the first side 11, and the booster antennas 42 and 44 are formed on the opposite side of the flexible substrate 15.

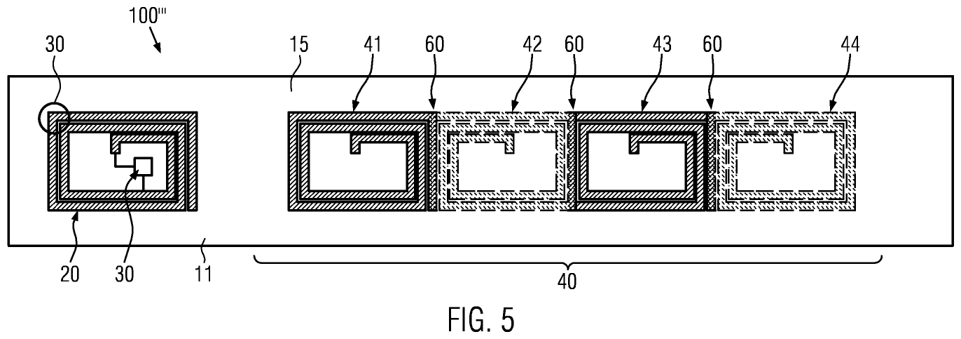

FIG. 5 schematically illustrates a two-dimensional view of the RFID ring 100′″, according to another embodiment of the present invention. In FIG. 5, the flexible substrate 15 is shown in the unwrapped configuration, such that the electronic components formed thereon are clearly visible.

The flexible substrate 15 of FIG. 5 is a double-sided substrate with the booster antennas 41 and 43 formed on the first side 11, and the booster antenna 42 and 44 formed on the opposite side (not visible in FIG. 5). As can be seen in the schematic representation of FIG. 5, the booster antennas 41, 42, 43 and 44 formed on different sides of the flexible substrate 15 have overlaying portions 60. For example, the booster antenna 41 has an overlaying portion 60 with the adjacent booster antenna 42 formed on the opposite side, the booster antenna 42 has an overlaying portion 60 with the adjacent booster antenna 43 formed on the first side 11, and the booster antenna 43 has an overlaying portion 60 with the adjacent antenna 44 formed on the opposite side of the flexible substrate 15. This configuration is advantageous because the reading and transmitting performance of the booster antennas with overlaying portions are enhanced with respect to the configuration where the antennas do not have overlaying portions.

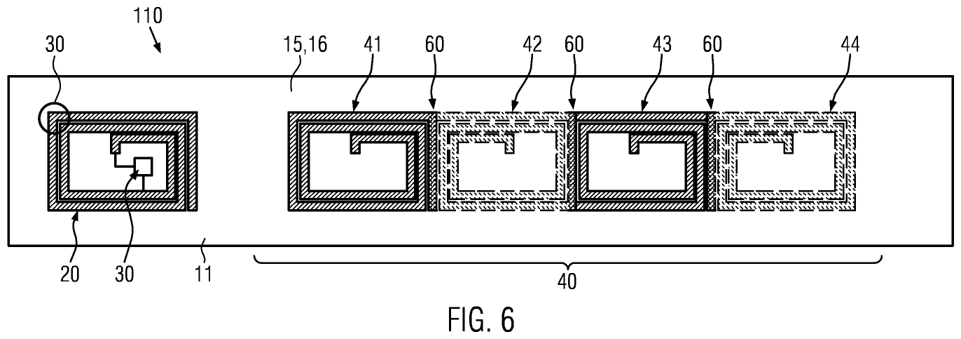

FIG. 6 schematically represents a two-dimensional view of the RFID ring 110, according to another embodiment of the present invention.

The RFID ring 110 comprises a multi-layered flexible substrate, which is formed by a first flexible substrate 15 and a second flexible substrate 16. The multilayered flexible substrate may be, for instance, a multi-layered PCB comprising a first flexible PCB 15 and a second flexible PCB 16. The flexible substrates 15 and 16 are layered to form a multilayered structure having a first side 11 and an opposite side, which is not visible in the figure. The flexible substrates 15 and 16 have one side in common, wherein no electronic components are formed. For the sake of clarity, the multilayered substrate is shown in the unwrapped configuration, such that the electronic components formed thereon are clearly visible.

In the configuration of FIG. 6, the booster antennas 41, 42, 43 and 44 are formed on different sides of the multilayered substrate, and they have overlaying portions. For example, the booster antenna 41 has an overlaying portion 60 with the next booster antenna 42 formed on the opposite side of the multilayered substrate. The booster antenna 42 has an overlaying portion 60 with the next booster antenna 43 formed on the side 11 of the multilayered substrate. The booster antenna 43 has an overlaying portion 60 with the next booster antenna 44 made on the opposite side of the multilayered substrate.

In the multilayered configuration, it is easier to manufacture and form the different electronic components on the different sides of the flexible substrate, and thanks to the overlaying portions, the reading and transmitting performances of the booster antennas are further enhanced.

As explained above, in the present disclosure, it is to be understood that “an n-fold rotational symmetry” refers to and protects both an exact n-fold rotational symmetry and a substantially n-fold rotational symmetry. For example, according to the definition of the present disclosure, a 4-fold rotational symmetry is satisfied by both configurations of FIG. 7A (exact 4-fold rotational symmetry) and 7B (substantially 4-fold rotational symmetry).

FIG. 7A schematically illustrates a cross-sectional view of a RFID ring 100 comprising one main antenna 20 and three booster antennas 41, 42 and 43, according to an embodiment of the present invention.

In the configuration of FIG. 7A, the main antenna 20 and the three booster antennas 41, 42 and 43 are placed along the length of the first flexible substrate 15 according to an exact 4-fold rotational symmetry. As visible in FIG. 7A, each pair of lines A, B, C and D define an angle of 90° along the length of the flexible substrate 15. The main antenna 20 is positioned in correspondence of the line A; the booster antenna 41 is positioned in correspondence of the line B; the booster antenna 42 is positioned in correspondence of the line C; and the booster antenna 43 is positioned in correspondence of the line D. Each antenna 20, 41, 42 or 43 is then perfectly symmetric with respect to the corresponding line, i.e. the lines A, B, C and D pass through the symmetry center of the corresponding antennas 20, 41, 42 and 43. In this way, as shown in the figure, it is possible to identify a series of four points P1, P2, P3 and P4, wherein each point is the center of symmetry of the corresponding antenna and is separated by an angle of 90° from the previous point and the next point of the series. Moreover, the antennas 20, 41, 42 and 43 have the same size. Therefore, the RFID ring 100 looks exactly the same after a rotation by a partial turn of 90°.

FIG. 7B schematically illustrates a cross-sectional view of a RFID ring 100 comprising one main antenna 20 and three booster antennas 41, 42 and 43, according to another embodiment of the present invention.

In the configuration of FIG. 7B, the main antenna 20 and the three booster antennas 41, 42 and 43 are placed along the length of the first flexible substrate 15 according to a substantially 4-fold rotational symmetry. As shown in the figure, it is possible to identify a series of 4 points P1′, P2′, P3′ and P4′, wherein each point belongs to an antenna and is separated by an angle of 90° from the previous point and the next point of the series.

Also in FIG. 7B, each pair of lines A′, B′, C′ and D′ define an angle of 90° along the length of the flexible substrate 15. The main antenna 20 is positioned in correspondence of the line A′; the booster antenna 41 is positioned in correspondence of the line B′; the booster antenna 42 is positioned in correspondence of the line C′; and the booster antenna 43 is positioned in correspondence of the line D′. However, in the configuration of FIG. 7B, the antennas 20, 41, 42 and 43 are not perfectly symmetric with respect to the corresponding lines.

For instance, with reference to the configuration of FIG. 7B, the main antenna 20 is not perfectly symmetric with respect to the line A′, but the portion of the antenna 20 at the right of the line A′ (clockwise direction) is bigger than the portion of the antenna 20 at the left of the line A′ (anti-clockwise direction). For instance, with reference to the configuration of FIG. 7B, the booster antenna 41 is not perfectly symmetric with respect to the line B′, but the portion of the antenna 41 at the right of the line B′ (clockwise direction) is smaller than the portion of the antenna 41 at the left of the line B′ (anti-clockwise direction). For instance, the portion of the booster antenna 42 at the right of the line C′ (clockwise direction) is smaller than the portion of the antenna 42 at the left of the line C′ (anti-clockwise direction). For instance, the portion of the booster antenna 43 at the right of the line D′ (clockwise direction) is smaller than the portion of the antenna 43 at the left of the line D′ (anti-clockwise direction). Moreover, the antennas 20, 41, 42 and 43 have different dimensions. Hence, the RFID ring 100 looks substantially the same (but not exactly the same) after some rotation by a partial turn of 90°.

It is to be understood that, even if FIGS. 7A and 7B illustrate, respectively, a 4-fold rotational symmetry configuration and a substantially 4-fold rotational symmetry configuration, the same reasoning applies to any type of n-fold rotational symmetry or substantial n-fold rotational symmetry, for instance to a (substantial) 3-fold rotational symmetry configuration, or a (substantial) 5-fold rotational symmetry configuration, or the like.

Even if the present invention has been described with reference to the embodiments described above, it is clear to the skilled person that it is possible to apply different modifications, variations and improvements of the present invention in light of the teachings described above and the field, and within the scope of the enclosed claims, without departing from the scope and purpose of the present invention.

Finally, those fields considered known to the skilled person have not been described to avoid covering in a useless way the described invention.

### REFERENCE NUMBERS

10: main body of RFID ring
11: first side of first flexible substrate
15: first flexible substrate
16: second substrate
20: main antenna
30: RFID chip
40: array of booster antennas
41, 42, 43, 44: booster antennas
50: common portion of adjacent antennas
60: overlaying portion of adjacent antennas
71, 72, 73, 74: capacitors
100, 100′, 100″, 10′″, 110: RFID rings
P1, P2, P3, P4, P1′, P2′, P3′, P4′: points

1. A Radio Frequency Identification (RFID) ring comprising:
a main body having an annular shape and comprising a flexible substrate extending along the perimeter of said main body;
a main antenna configured to provide energy to a RFID chip;
an array of booster antennas comprising two or more booster antennas, said booster antennas being coupled to said main antenna,
wherein said main antenna and said booster antennas are formed on said flexible substrate and they are one adjacent to the other, and
wherein said main antenna and said booster antennas are distributed along the length of said flexible substrate so that any antenna of said array is coupled to said main antenna either directly or indirectly via one or more of the other antennas of said array.

2. The RFID ring according to claim 1, wherein said main antenna and said booster antennas are distributed along the length of said flexible substrate so that, an induced electro-magnetic signal is generated in said main antenna either directly or indirectly via one or more of said booster antennas of said array, irrespective of the direction of an incoming magnetic field.

3. The RFID ring according to claim 1, wherein said main antenna and said booster antennas are evenly distributed along said length of said flexible substrate.

4. The RFID ring according to claim 1, wherein said main antenna and said booster antennas are distributed along said length of said flexible substrate according to an n-fold rotational symmetry.

5. The RFID ring according to claim 1, wherein said array of booster antennas comprises three or more booster antennas, preferably three or four booster antennas.

6. The RFID ring according to claim 1, wherein said flexible substrate is a single-sided substrate and said main antenna and said array of booster antennas are formed on the same side of said flexible substrate

7. The RFID according to claim 6, wherein said array of booster antennas is formed so that at least two adjacent booster antennas have one portion in common, preferably all adjacent booster antennas have one portion in common.

8. The RFID ring according to claim 1, wherein said flexible substrate is a double-sided substrate having a first side and a second side, and wherein said main antenna is formed on said first side and at least one booster antenna is formed on said second side.

9. The RFID ring according to claim 8, wherein said array of booster antennas is split between said first side and said second side, so that at least one booster antenna is formed on said first side and at least one booster antenna is formed on said second side.

10. The RFID ring according to claim 1, wherein said main body further comprises an additional flexible substrate layered on said flexible substrate, and wherein said main antenna is formed on a first side of said flexible substrate and at least one booster antenna is formed on a second side of said additional substrate.

11. The RFID ring according to claim 10, wherein said array of booster antennas is split between said flexible substrate and said additional flexible substrate, so that at least one booster antenna is formed on said first side of said substrate and at least one booster antenna is formed on a second side of said additional substrate.

12. The RFID ring according to claim 8, wherein said array of booster antennas is formed so that at least two adjacent booster antennas formed on different sides have one overlaying portion, preferably all adjacent booster antennas formed on different sides have one overlaying portion.

13. The RFID ring according to claim 1, wherein said main antenna and/or said booster antennas are etched antennas.

14. The RFID ring according to claim 1, wherein said main antenna and/or said booster antennas are printed antennas.

15. The RFID ring according to claim 1, wherein said main antenna and/or said booster antennas are wire-embedded antennas.
